(19) United States
(12) Patent Application Publication
(10) Pub. No.: US 2006/0096687 A1
(43) Pub. Date: May 11, 2006

(54) Tubeless pneumatic tire, and method of making same

(75) Inventors: Toshio Yamagiwa, Saitama (JP); Hirohisa Takahashi, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/267,021

(22) Filed: Nov. 4, 2005

(30) Foreign Application Priority Data
Nov. 5, 2004 (JP) 2004-321914

(51) Int. Cl. B60C 19/12

(52) U.S. Cl. 152/504; 156/115

(57) ABSTRACT

A tubeless pneumatic tire is provided which can sufficiently prevent air leakage from a puncture hole formed through a tread portion of the tire by a nail or the like, while ensuring a desired cushioning performance of the tire during normal operation. The tubeless pneumatic tire includes an annular tread portion, and a pair of sidewall portions extending radially inwardly from laterally opposite sides of the tread portion. An intermediate liner is provided inside of the tread portion, along with a first release sheet on the outer surface of the intermediate liner, and a second release sheet on the inner surface of the intermediate liner. A sealing chamber, for encapsulating a puncture sealant, is further provided inside of the intermediate liner. The puncture sealant may include both fibers and particles, to enhance sealing of the puncture hole.

### CROSS-REFERENCE TO RELATED APPLICATIONS

The present invention claims priority under 35 USC 119 based on Japanese patent application No. 2004-321914, filed on Nov. 5, 2004. The subject matter of this priority document is incorporated by reference herein.

### BACKGROUND OF THE INVENTION

1. Field of the Invention

The present invention relates to a tubeless pneumatic tire having a puncture sealant encapsulated inside of the tire.

2. Description of the Background Art

A pneumatic tire, having an encapsulated puncture sealant enclosed within the tire, is known in the art. In such a pneumatic tire, when a puncture hole is formed through a tread portion by a nail or the like, the puncture sealant inside of the pneumatic tire functions to slow down or prevent the leakage of air from the tire. Examples of pneumatic tires having encapsulated puncture sealant therein are disclosed, for example, in Japanese Patent No. 3497281 and Japanese Laid-open Patent No. 2000-142018.

More specifically, a tube, encapsulating the puncture sealant in the form of a gel, is provided on the inner surface of the tread portion of the pneumatic tire, in close contact with the inner surface. When a puncture hole is formed through the tread portion and the tube by a nail or the like, the puncture sealant is forced into the puncture hole by the pressurized air present in the tire, thus plugging the puncture hole.

In the conventional pneumatic tire mentioned above, however, a reduction in the elasticity of the tread portion, designed into the tire to ensure tire cushioning performance, causes a reduction in elastic force for plugging the puncture hole. Accordingly, it is difficult to ensure both the tire cushioning performance and the puncture hole plugging performance.

It is, accordingly, an object of the present invention to provide a pneumatic tire which can sufficiently slow or prevent air leakage from a puncture hole formed through a tread portion of the tire by a nail or the like, while ensuring the required tire cushioning performance.

### SUMMARY

In accordance with a first aspect of the invention, a tubeless pneumatic tire is presented which comprises an annular tread portion (e.g., a tread portion 2 in the illustrative embodiment) and a pair of sidewall portions (e.g., a pair of sidewall portions 3 in the illustrative embodiment) extending radially inwardly from respective laterally opposed side edges of the tread portion. An intermediate liner (e.g., an intermediate liner 11 in the illustrative embodiment) is provided inside of the tread portion with two releasing members (e.g., a first release sheet 10 and a second release sheet 12 in the illustrative embodiment) being provided on the inner and outer surfaces, respectively, of the intermediate liner. A sealing chamber (e.g., a sealing chamber 15 in the illustrative embodiment) for encapsulating a puncture sealant (e.g., a puncture sealant 14 in the illustrative embodiment) is further provided inside of the intermediate liner. With this configuration, the intermediate liner does not adhere to the tread portion, but is freely expandable. Accordingly, a puncture hole formed through the intermediate liner can be displaced in its closing direction by the elastic force of the intermediate liner.

In accordance with a second aspect of the invention, each of the two releasing members comprises a release sheet. With this configuration, the adhesion of the intermediate liner to the tread portion can be prevented using a minimum space.

In accordance with a third aspect of the invention, the puncture sealant comprises a sealing liquid (e.g., a sealing liquid 16 in the illustrative embodiment) containing fibers (e.g., short fibers 17 in the illustrative embodiment). With this configuration, the fibers are forced into the puncture hole of the intermediate liner by the air pressure in the tire, whereby the presence of the fibers slightly enlarges the puncture hole, and whereby the fibers are maintained within the puncture hole by means of the elastic properties of the intermediate liner.

In accordance with a fourth aspect of the invention, the puncture sealant comprises a sealing liquid containing a mixture of fibers and particles (e.g., particles 18 in the illustrative embodiment). With this configuration, a gap between the puncture hole and fibers staying in the puncture hole can be filled with the particles.

In accordance with a fifth aspect of the invention, the release sheet provided on the inner surface of the intermediate liner is water-soluble. With this configuration, the water-soluble release sheet is dissolved into the sealing liquid at the time of filling the sealing chamber with puncture sealant. Accordingly, the water-soluble release sheet does not interfere with the fibers, contained in the sealing liquid, being forced into the puncture hole.

According to the first aspect of the invention, the intermediate liner does not adhere to the tread portion, but is freely expandable. As a result, the puncture hole of the intermediate liner can be displaced in its closing direction by the elastic force of the intermediate liner. Accordingly, the puncture hole at the tread portion can be efficiently closed by the synergistic effect of the contraction of the intermediate liner and the puncture sealant.

According to the second aspect of the invention, in addition to the above effect, the adhesion of the intermediate liner to the tread portion can be prevented with a minimum space. Accordingly, the capacity of the sealing chamber can be sufficiently ensured.

According to the third aspect of the invention, in addition to the above effects, the fibers forced into the puncture hole of the intermediate liner by the air pressure in the tire can enlarge the puncture hole, whereby the fibers are maintained within the puncture hole. Accordingly, the puncture hole at the tread portion can be reliably closed by the fibers contained in the sealing liquid and by the contraction of the intermediate liner.

According to the fourth aspect of the invention, in addition to the above effects, the gaps between the fibers which reside in the puncture hole can be filled with the particles. Accordingly, the reliability of the puncture sealant can be improved.

According to the fifth aspect of the invention, in addition to the above effects, the water-soluble release sheet is dissolved into the sealing liquid at the time of filling the sealing chamber with the puncture sealant. As a result, the water-soluble release sheet does not interfere with the fibers, contained in the sealing liquid, being forced into the puncture hole. Accordingly, the puncture hole can be closed more reliably.

Modes for carrying out the present invention are explained below by reference to a selected illustrative embodiment of the present invention, shown in the attached drawings. The above-mentioned object, other objects, characteristics and advantages of the present invention will become apparent form the detailed description of the embodiment of the invention presented below in conjunction with the attached drawings, in which:

### BRIEF DESCRIPTION OF THE DRAWINGS

FIG. 1 is a partially cutaway perspective view of a tubeless pneumatic tire according to an illustrative embodiment of the present invention.

FIG. 2 is a cross section of the tubeless pneumatic tire of FIG. 1, taken along the line A-A therein.

FIG. 3 is an enlarged side sectional detail view of a selected portion of the tubeless pneumatic tire of FIGS. 1-2, taken along a vertical plane normal to that of FIG. 2.

FIG. 4 is a sequential detail view of the tubeless pneumatic tire similar to FIG. 3, and illustrating a condition where a puncture hole is formed through the tread portion of the tire by a nail.

FIG. 5 is a sequential detail view of the tubeless pneumatic tire similar to FIG. 4, illustrating a condition where the nail is being removed from the puncture hole.

FIG. 6 is a sequential detail view of the tubeless pneumatic tire similar to FIG. 5, illustrating a condition where the puncture hole is closed by a puncture sealant; and

FIG. 7 is a cross sectional detail view of a sealed puncture portion of the tubeless pneumatic tire of FIG. 6, taken along the line B-B therein.

### DETAILED DESCRIPTION

A selected illustrative embodiment of the invention will now be described in some detail, with reference to the drawings. It should be understood that only structures considered necessary for clarifying the present invention are described herein. Other conventional structures, and those of ancillary and auxiliary components of the system, are assumed to be known and understood by those skilled in the art. This illustrative embodiment is a motorcycle tire to which the present invention is applied.

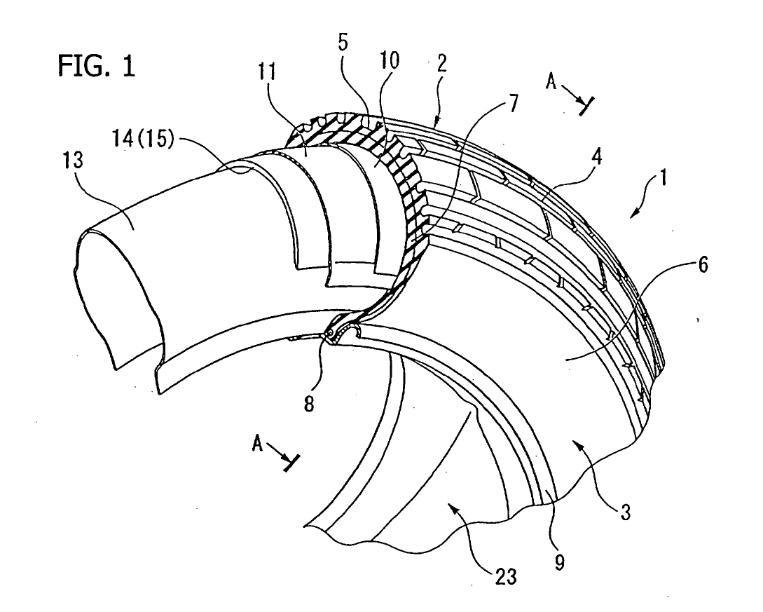

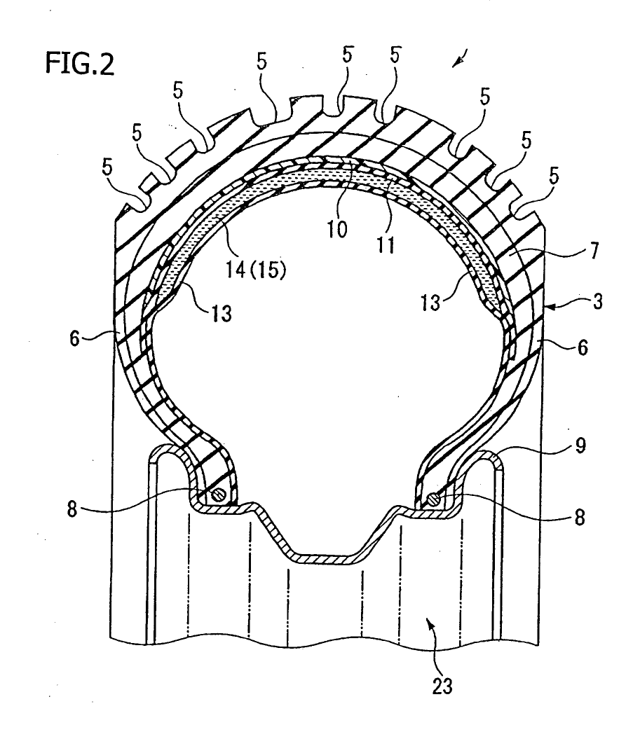

FIG. 1 shows an example of a tubeless pneumatic tire in this illustrative embodiment. As shown in FIG. 1, reference numeral 1 generally denotes the tubeless pneumatic tire, which is mounted on a rim 9 of a three-spoke type cast wheel 23. As shown in FIG. 2, the tire 1 is generally composed of a tread portion 2 having an arcuate cross section, and a pair of sidewall portions 3 extending, respectively, from laterally opposite sides of the tread portion 2 (in the direction along the width of the tire 1) toward the radially inner ends of the tire 1.

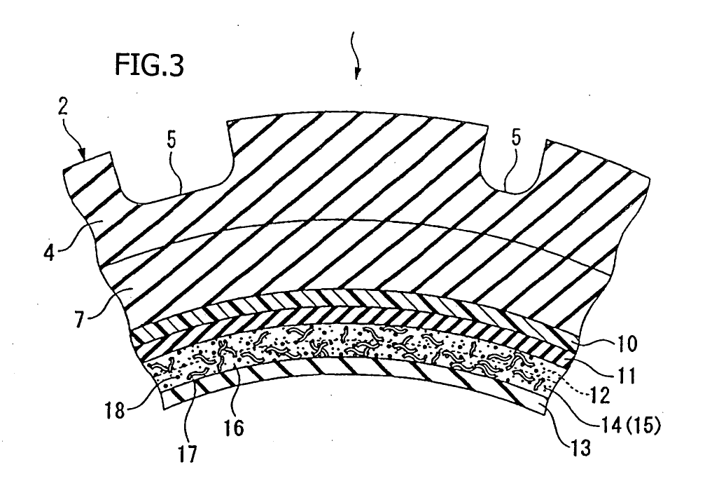

As shown in FIG. 3, the outer surface of the tread portion 2 is formed by a tread rubber 4 adapted to come into contact with a road surface during rolling movement of the tire 1. The tread rubber 4 is formed of a rubber material having relatively low elasticity, because it is required to ensure a coefficient of friction and to have a high wear resistance. Further, the outer surface of the tread rubber 4 is formed with a tread pattern 5 of grooves or slits formed therein. The tread pattern 5 improves the coefficient of friction and wear resistance of the tread rubber 4, and also improves the performance of water ejection from the tread rubber 4. On the other hand, the outer surface of each sidewall portion 3 is formed by a rubber sidewall 6 that is integrally formed with the tread rubber 4.

The inner surface of the tread portion 2 and the sidewall portions 3 is uniformly formed with a carcass ply 7 for bearing a load. The carcass ply 7 is formed by arranging a plurality of fibrous carcass cords in a direction inclined a predetermined angle with respect to the circumferential direction of the tire 1. A pair of bead wires 8 are embedded in the laterally opposed side edges of the carcass ply 7. Thus, the tread rubber 4 and the rubber sidewalls 6 are attached to the outer circumferential surface of the carcass ply 7, to thereby integrate the tread portion 2 and the sidewall portions 3. The tire 1 is generally classified as a radial ply tire or a bias ply tire, according to selected factors such as the angle of inclination of the carcass cords, the material of the carcass cords, etc. In this illustrative embodiment, the tire 1 is a bias ply tire.

Each bead wire 8 is formed as a ring of high-carbon steel wires bundled together, and has a function of fixing the opposite side edges of the carcass ply 7 to the rim 9 of the cast wheel 23, to thereby retain the air pressure inside the tire 1. The bead wire 8 has another function of resisting separation of the tire 1 from the rim 9 in the case of puncture of the tire 1.

A first release sheet 10 is attached to the inner surface of the carcass ply 7, extending over a range from one of the sidewall portions 3 at a location near the upper side thereof, along the tread portion 2, to opposed sidewall portion 3 at a location near the upper side thereof. The first release sheet 10 is provided for the purpose of preventing adhesion of an intermediate liner 11 (to be hereinafter described) to the carcass ply 7, in the process of vulcanization of the tire 1 during manufacture.

The intermediate liner 11 is provided inside of the first release sheet 10, extending over a range from a position radially inside of one end of the first release sheet 10 in one of the sidewall portions 3, i.e., from near the radial center of one of the sidewall portions 3, along the tread portion 2, to near the radial center of the other sidewall portion 3. The intermediate liner 11 is formed of a rubber material having high hermeticity and high elasticity, using natural rubber or the like as a raw material.

A water-soluble second release sheet (release sheet) 12 is provided inside of the intermediate liner 11. The second release sheet 12 is shown only in FIG. 3, in which a broken line represents the position of the second release sheet 12 before dissolution into the water of the puncture sealant 14. Like the first release sheet 10, the second release sheet 12 is provided for the purpose of preventing the adhesion of the intermediate liner 11 to a member adjacent thereto during the process of vulcanization of the tire 1. Since the second release sheet 12 is soluble in water, it is dissolved into the water contained in a puncture sealant 14 at the time of filling the sealing chamber 15 with puncture sealant 14, to be hereinafter described. Accordingly, the intermediate liner 11 can expand and contract except its opposite side edges, which are fixed to the carcass ply 7. Further, since the second release sheet 12 is dissolved into the water contained in the puncture sealant 14, the puncture sealant 14 can easily act on the intermediate liner 11.

An inside liner 13 is provided inside of the sidewall portions 3 and the tread portion 2, extending over a range from the radially inner end of one of the sidewall portions 3, along the inside of the second release sheet 12, to the radially inner end of the other sidewall portion 3. The inside liner 13 is formed of a rubber material similar to that of the intermediate liner 11. The inside liner 13 is attached to the inner surface of the carcass ply 7 at its opposite side edges, and to the inner surface of the intermediate liner 11 at its opposite side edges. The opposite side edges of the second release sheet 12 are fixed to the inside layer 13, thereby defining the sealing chamber 15 for encapsulating the puncture sealant 14 as a closed space between the inside liner 13 and the second release sheet 12. The sealing chamber 15 is filled with the puncture sealant 14. Since the second release sheet 12 is dissolved in the water contained in the puncture sealant 14, the sealing chamber 15 is formed between the inside liner 13 and the intermediate liner 11. Accordingly, the tire 1 has a three-layer structure consisting of the tread rubber 4, the intermediate liner 11, and the inside liner 13.

The puncture sealant 14 functions to minimize or prevent outward leakage of air from the tire 1 when a puncture hole or tear made by a nail or the like reaches the inside space of the tire 1. The puncture sealant 14 is composed of a sealing liquid 16 in the form of a gel at ordinary temperature (e.g., 20 deg. Celsius), short fibers (fibers) 17 mixed in the sealing liquid 16, and particles 18 of ceramic or the like mixed in the sealing liquid 16. The short fibers 17 and the particles 18 function to quickly and effectively close a puncture hole made by a nail or the like. More specifically, the short fibers 17 enter the puncture hole in association with the flow of the puncture sealant 14 through the puncture hole, and the particles 18 enter the gaps between the short fibers 17 which are present in the puncture hole. The configuration of this puncture sealant 14 is merely illustrative, and various puncture sealants capable of sealing the puncture hole may be used in the present invention.

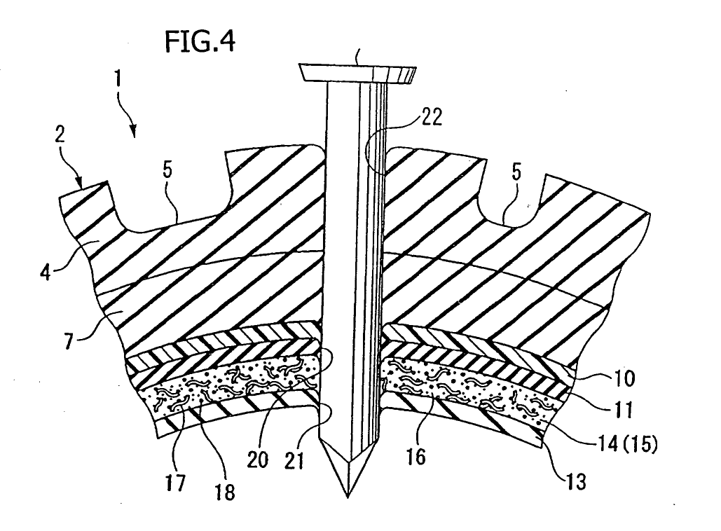

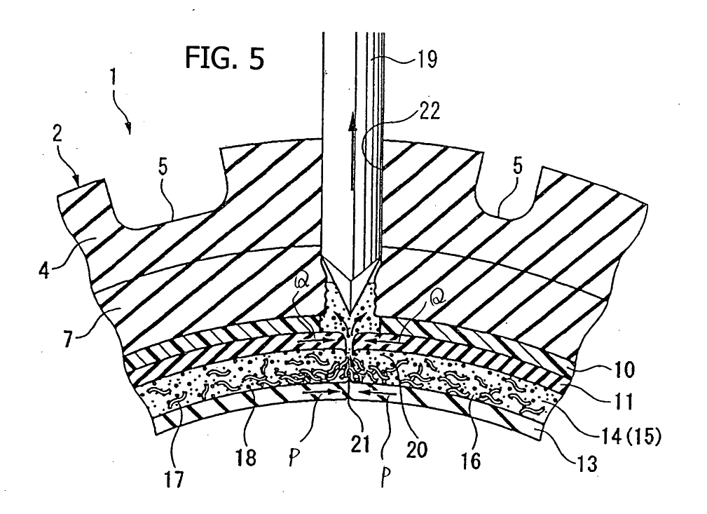

The operation of the inventive tubeless pneumatic tire during a tread puncture will now be described with reference to FIGS. 4 to 7. When a nail 19 pierces the tread portion 2 so as to extend through the tire to the intermediate liner 13 as shown in FIG. 4, holes 22, 20, and 21 due to the piercing of the nail 9 are formed through the tread rubber 4, the intermediate liner 11, and the inside liner 13, respectively. At this time, the peripheries of the holes 20 and 21 of the intermediate liner 11 and the inside liner 13 are drawn radially inward toward the inside of the tire 1, as shown in FIG. 4. When the nail 19 is displaced in a direction of coming out of the tread portion 2 as shown in FIG. 5, the holes 21 and 20 of the inside liner 13 and the intermediate liner 11, both having elasticity higher than that of the tread rubber 4, undergo forces in a direction of closing the holes 21 and 20 (as shown by arrows P and Q in FIG. 5). Accordingly, the hole 21 of the inside liner 13, freely expandable in the vicinity of the tread portion 2, is completely closed by the high elasticity of the inside liner 13, and the intermediate liner 11, permitted to slide on the first release sheet 10, starts to contract.

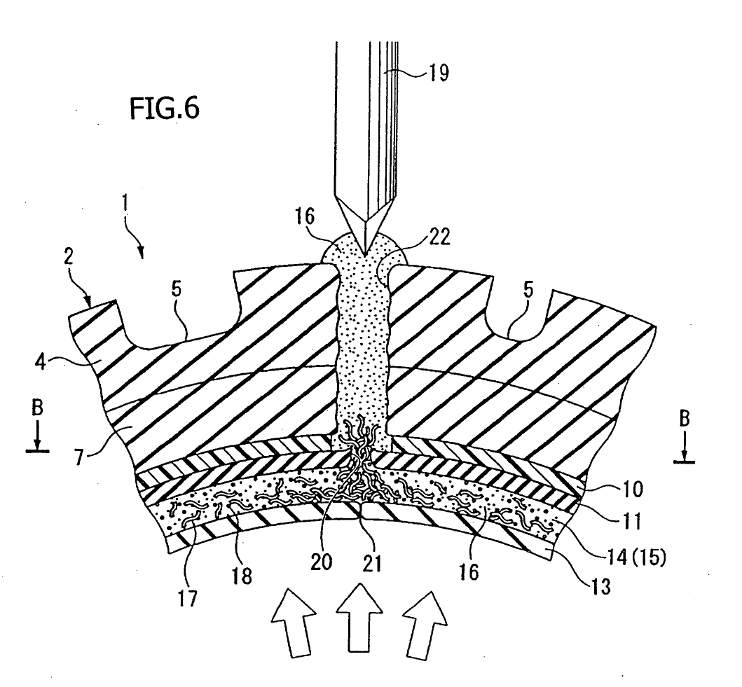

However, the air pressure (represented by open arrows in FIG. 6) inside the tire 1 cannot be suppressed by the elastic forces of the inside liner 13 and the intermediate liner 11. As a result, the puncture sealant 14 is forced by the air pressure in the tire 1 to flow radially outward, out through the hole 20 of the intermediate liner 11 into the hole 22 of the tread rubber 4 and to finally come out of the hole 22 as shown in FIG. 6. At this time, the flow of the puncture sealant 14 toward the inside of the tire 1 is suppressed by the air pressure in the tire 1.

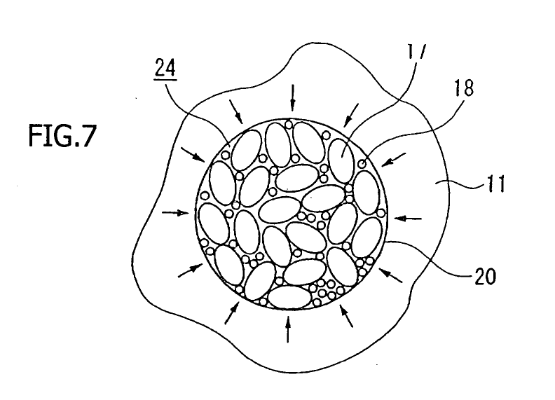

In association with the flow of the puncture sealant 14 through the hole 22 toward the outside of the tire 1, the short fibers 17 contained in the puncture sealant 14 are gradually forced into the hole 20 of the intermediate liner 11 as shown in FIG. 6, thereby gradually closing the hole 20. At the same time, as shown in FIG. 7, the particles 18 contained in the puncture sealant 14 are also forced into the hole 20 of the intermediate liner 11 to enter the gaps 24 between the short fibers 17, and between the short fibers 17 and the hole 20, thereby substantially filling the gaps 24. Thus, the hole 20 of the intermediate liner 11 is completely closed by the puncture sealant 14.

When the air pressure in the tire 1 becomes balanced to the elastic force of the intermediate liner 11 (as shown by arrows in FIG. 7) to cause the stop of the flow of the puncture sealant 14, the diameter of the hole 20 is slightly enlarged by the short fibers 17 and the particles 18, as compared with that shown in FIG. 5. As a result, the closed condition of the hole 20 by the short fibers 17 and the particles 18 can be reliably retained by the elastic force of the intermediate liner 11.

According to this illustrative embodiment, the intermediate liner 11 does not adhere to the tread portion 2, but it is permitted to slide on the first release sheet 10 and is freely expandable. Accordingly, the hole 20 of the intermediate liner 11 can be displaced in its closing direction (can be reduced in diameter) by the elastic force of the intermediate liner 11. As a result, the hole 20 of the intermediate liner 11 can be efficiently closed by the synergistic effect of the contraction of the intermediate liner 11 and the puncture sealant 14.

Further, the short fibers 17 contained in the puncture sealant 14, which are forced into the hole 20 of the intermediate liner 11 by the air pressure in the tire 1, can be retained as plugging members on the periphery of the hole 20, by means of the elastic properties of the intermediate liner 11. Accordingly, the synergistic effect of the short fibers 17, the particles 18, and the sealing liquid 16 of the puncture sealant 14 can be exhibited, and the hole 20 of the intermediate liner 11 can be reliably closed by this synergistic effect and the contraction of the intermediate liner 11.

By forming the three-layer structure consisting of the tread rubber 4, the intermediate liner 11, and the inside liner 13, a tire structure similar to that of a tube-type pneumatic tire, having an inner tube, can be obtained. Accordingly, a puncture sealant whose performance has been proven in a conventional tube pneumatic tire can be utilized to thereby reduce the cost and improve the reliability.

The present invention is not limited to this illustrative embodiment mentioned above, but may be applied to any pneumatic tires for a vehicle such as an automobile other than a motorcycle and for an aircraft, for example. While a working example of the present invention has been described above, the present invention is not limited to the working example described above, but various design alterations may be carried out without departing from the present invention as set forth in the claims.

What is claimed is:

1. A pneumatic tire, comprising:
an annular tread portion,
a pair of sidewall portions extending radially inwardly from laterally opposite sides of the tread portion,
an intermediate liner provided inside of the tread portion and having inner and outer surfaces, wherein a releasing member is provided on each of the inner and outer surfaces of the intermediate liner, respectively, and
a sealing chamber which encapsulates a puncture sealant, said sealing chamber disposed inside of the intermediate liner.

2. The pneumatic tire according to claim 1, wherein each of the two releasing members comprises a release sheet.

3. The pneumatic tire according to claim 2, wherein the puncture sealant comprises a sealing liquid which contains fibers.

4. The pneumatic tire according to claim 2, wherein the puncture sealant comprises a sealing liquid containing a mixture of fibers and particles.

5. The pneumatic tire according to claim 2, wherein the release sheet provided on the inner surface of the intermediate liner is water-soluble.

6. The pneumatic tire according to claim 1, wherein the puncture sealant comprises a sealing liquid which containing fibers.

7. The pneumatic tire according to claim 6, wherein the release sheet provided on the inner surface of the intermediate liner is water-soluble.

8. The pneumatic tire according to claim 1, wherein the puncture sealant comprises a sealing liquid containing a mixture of fibers and particles.

9. The pneumatic tire according to claim 8, wherein the release sheet provided on the inner surface of the intermediate liner is water-soluble.

10. The pneumatic tire according to claim 1, wherein an inside liner is provided radially inward of the intermediate liner, and wherein the release sheet provided on the inner surface of the intermediate liner is disposed between the inside liner and the intermediate liner during a vulcanization process of the tire.

11. The pneumatic tire according to claim 1, wherein an inside liner is provided radially inward of the intermediate liner, and wherein the release sheet provided on the inner surface of the intermediate liner is disposed between the inside liner and the intermediate liner within the sealing chamber.

12. A tubeless pneumatic tire, comprising:
an annular tread portion,
a pair of sidewall portions extending radially inwardly from laterally opposite sides of the tread portion,
an intermediate liner provided inside of the tread portion and having inner and outer surfaces, wherein a releasing member is provided on the outer surface of the intermediate liner,
an inside liner disposed radially inside of the intermediate liner and cooperating with the intermediate liner to define a sealing chamber therebetween, and
a puncture sealant gel disposed in said sealing chamber.

13. The tubeless pneumatic tire according to claim 12, wherein the releasing member comprises a release sheet.

14. The tubeless pneumatic tire according to claim 12, wherein the puncture sealant comprises a sealing liquid which contains fibers.

15. The tubeless pneumatic tire according to claim 12, wherein the puncture sealant comprises a sealing liquid containing a mixture of fibers and particles.

16. The tubeless pneumatic tire according to claim 12, further comprising a water-soluble release sheet provided on the inner surface of the intermediate liner.

17. A tubeless pneumatic tire, comprising:
an annular tread portion,
a pair of sidewall portions extending radially inwardly from from laterally opposite sides of the tread portion,
an intermediate liner provided inside of the tread portion and having inner and outer surfaces, wherein a releasing member is provided on each of the inner and outer surfaces of the intermediate liner, respectively, and
a sealing chamber disposed inside of the intermediate liner, wherein said sealing chamber encapsulates a puncture sealant which is a liquid suspension comprising both fibers and particles.

18. A method of manufacturing a tubeless pneumatic tire, the tubeless pneumatic tire comprising
an annular tread portion and
a pair of sidewall portions extending from the laterally opposite sides of the tread portion toward the radial inside of the tire,
an intermediate liner provided inside of the tread portion,
an outer releasing member provided on an outer surface of the intermediate liner,
a sealing chamber for encapsulating a puncture sealant is further provided inside of the intermediate liner, and
an inside liner provided inside of the sealing chamber,
the method of manufacturing the tubeless pneumatic tire comprising the following method steps:
assembling the tire such that the annular tread portion and sidewall portions form an outer layer, the intermediate liner is secured inside the tread portion, the sealing chamber is provided inside of the intermediate liner, the outer releasing member is positioned between the intermediate liner and the tread portion, and an inner releasing member is positioned between the intermediate liner and the inside liner so as to be received within the sealing chamber,
vulcanizing the tire, and
filling the sealing chamber with a puncture sealant.

19. The method of manufacturing a tubeless pneumatic tire of claim 18, wherein
the inner releasing member is soluble in the puncture sealant, and
when the sealing chamber is filled with puncture sealant, the inner releasing member dissolves so that the puncture sealant is retained in a closed space between the inside liner and the intermediate liner.
